(19) United States
(12) Patent Application Publication
(10) Pub. No.: US 2017/0148081 A1
(43) Pub. Date: May 25, 2017

(54) METHOD AND SYSTEM FOR RECOMMENDING RELEVANT MERCHANTS FOR A CONSUMER AT A GIVEN GEOGRAPHICAL LOCATION BY EVALUATING THE STRENGTH OF THE INTERSECT BETWEEN CONSUMER VECTORS AND MERCHANT VECTORS

(71) Applicant: MasterCard International Incorporated, Purchase, NY (US)

(72) Inventor: Rohit Chauhan, Somers, NY (US)

(21) Appl. No.: 14/947,284

(22) Filed: Nov. 20, 2015

(51) Int. Cl. G06Q 30/06

(52) U.S. Cl. CPC G06Q 30/0631

(57) ABSTRACT

A method is provided for recommending relevant merchants for a consumer at a given geographical location. The method generally includes identifying, using a computing processing unit, transactions processed over at least one payment device network as being associated with a payment network account of a consumer. The identified transactions are then parsed to extract ISO 8583 formatted data. By evaluating the extracted ISO 8583 formatted data and determining a location of the consumer, a list containing merchant that are available for more purchases and within a predetermined distance to a geographical location of the consumer are determined. Furthermore, the list may be refined by evaluating the strength of the intersect between a plurality of consumer vectors and a plurality of merchant vectors.

### FIELD OF THE INVENTION

The present invention relates to methods and systems for recommending relevant merchants to consumers, and more particularly, to methods and systems for recommending relevant merchants to a consumer at a given geographical location.

### BACKGROUND OF THE INVENTION

The widespread use of mobile devices, such as smartphones and the increasing sophistication of these devices have created societies in which personal, mobile computing power has become nearly ubiquitous. The advancement of these smartphones has provided new channels for retailers or merchants to reach their potential customers and to advertise their goods and/or services. More specifically, many merchants have implemented sales and marketing strategies, such as advertisements, that can be deployed via mobile devices. One of the popular advertising methods utilizing the mobile devices is transmitting advertisements for retailers to the mobile devices of potential consumers who are in close proximity to the retailers, where the locations of the potential consumers can be determine via their smartphones. However, since this advertising method transmits the advertisements to all mobile devices that are near the retailer without considering purchase habits and preferences of the potential consumers, the majority of the potential consumers may be receiving information that are not useful to them. Thus, this method of advertising is minimally effective or not effective at all.

### SUMMARY OF THE INVENTION

According to an embodiment of the present invention, a method for recommending relevant merchants for a consumer at a given geographical location includes identifying transactions processed over at least one payment device network as being associated with a payment network account of a consumer; parsing the identified transactions to extract ISO 8583 formatted data, wherein the ISO 8583 formatted data representing, where present, for each of the identified transactions, at least an associated merchant category code, an associated merchant category name, an associated merchant name, an associated merchant address and an associated transaction amount; aggregating, using a computing processing unit, the associated transaction amounts for the identified transactions for each of the associated merchant categories, wherein all of the identified transactions for each of the associated merchant categories occurred in a predetermined time period; comparing, using the computing processing unit, the aggregated amount for each of the associated merchant categories with a predetermined total threshold purchase amount of a respective merchant category of the consumer and wherein, for each of the aggregated amounts being less than the predetermined total threshold purchase amount, identifying the associated merchant category as a target merchant category; determining geographical location of the consumer via a global positioning system (GPS) receiver of a mobile device of the consumer; identifying, using the computing processing unit, merchants of each of the identified associated merchant categories within a predetermined distance to the geographical location of the consumer; and transmitting, using a transmitting unit, an alert including a list of the identified merchants to the mobile device of the consumer.

A system for recommending relevant merchants for a consumer at a given geographical location includes one or more computing processing units (CPUs), one or more database management systems, a member unit and a transmitting unit. The one or more computing processing units are configured to monitor financial transactions being transmitted over one or more payment device networks and to execute a plurality of algorithm models. Each of the one or more database management systems includes a user account database, a transaction database and a merchant database. The user account database is configured to store data associated with the consumer. The transaction database is configured to store financial transactions identified by the one or more computing processing units. The merchant database is configured to store data structures corresponding to a relevant merchant profile, a plurality of consumer vectors and a plurality of merchant vectors. The member unit is configured to provide a graphical user interface to the consumer for registering to the system, creating a user account profile and inputting user preference data. A transmitting unit is configured to transmit an alert including a list of merchants in the relevant merchant profile to the consumer.

These and other aspects of the present invention will be better understood in view of the drawings and following detailed description.

### BRIEF DESCRIPTION OF THE DRAWINGS

FIG. 1 illustrates schematically the process and parties typically involved in consummating a cashless transaction;

FIG. 2 is a block diagram of a system according to an embodiment of the present invention;

FIG. 3 is a block diagram of the system, according to an embodiment of the present invention, integrated with a payment device network;

FIG. 4 is a flowchart of a method for recommending relevant merchants to a consumer at a given geographical location, according to the present invention; and

FIG. 5 is an exemplary illustration of refining of the relevant merchants for the consumer at the given geographical location, according to the present invention.

### DETAILED DESCRIPTION OF PREFERRED EMBODIMENTS

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

The present disclosure is described below with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, may be implemented by computer program instructions.

Providing of such computer program instructions to the “server,” “device,” “computing device,” “general purpose computer,” “computer device,” “system,” or “specialized computing device” causes a machine to be produced, such that the computer program instructions when executed create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The present invention is not necessarily limited to any particular number, type or configuration of processors, nor to any particular programming language, memory storage format or memory storage medium.

As used herein, a “payment device network” refers to a network or system such as the systems operated by MasterCard International Incorporated, or other networks, which electronically process payment transactions on behalf of merchants, acquirers, issuers and cardholders. The payment device network acts as an intermediary between these parties, such as between acquirers and issuers. The payment device network may include a network of operatively linked computer processing units (CPU's). The payment network is not accessible by the general public.

As used herein, “financial transactions” refers to all debit and credit transactions, including, but not limited to, those based on payment cards, fobs (or other near-field-communication (NFC) devices), cellular phones, smartphones, and web-enabled systems.

As used herein, a “relevant merchant” refers to a store/business, located within a predetermined geographical location of a consumer that the consumer will most likely make a purchase from, based on his/her spending behaviors/patterns.

The subject invention involves collecting and analyzing details at an individual consumer level based on information collected over a payment device network. The system of the subject invention may be utilized to monitor purchases of the consumer to evaluate and recommend relevant merchants for the consumer at a given geographical location. It is noted that any form of payment over a payment device network may be utilized within the system. The monitoring and evaluation of the consumer may be conducted in real-time to incorporate latest activities.

The subject invention may utilize information that is embedded in the financial transactions, e.g., in ISO 8583 format. The subject invention, therefore, may be implemented with a system that is operatively connected to one or more payment device networks, with little or no modification of the respective payment device networks.

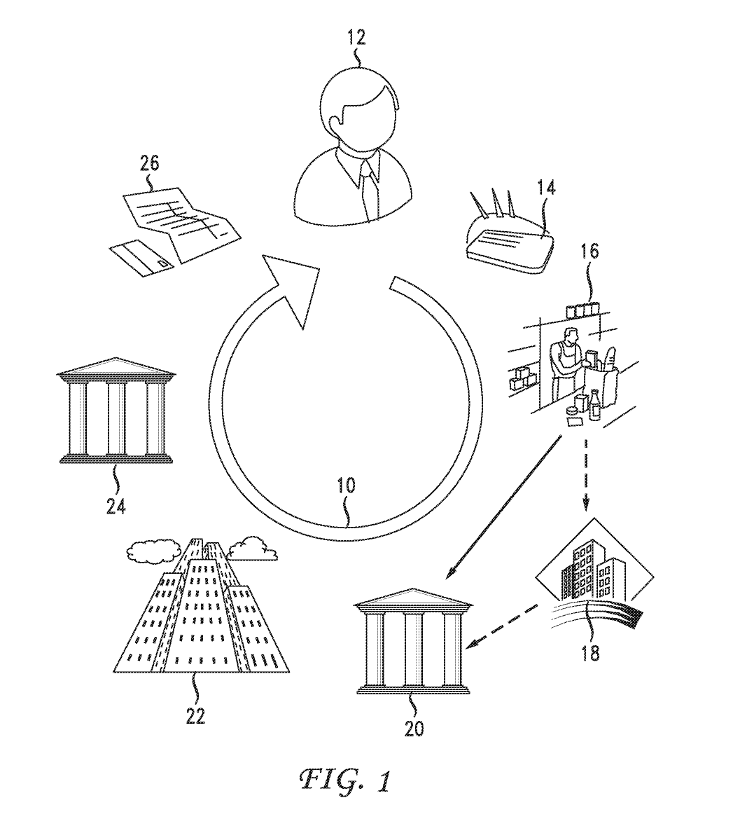

The process and parties typically involved in consummating a cashless payment transaction can be visualized for example as presented in FIG. 1, and can be thought of as a cycle, as indicated by arrow 10. A device holder 12 may present a payment device 14, for example a payment card, transponder device, NFC-enabled smart phone, among others and without limitation, to a merchant 16 as payment for goods and/or services. For simplicity the payment device 14 is depicted as a credit card, although those skilled in the art will appreciate the present disclosure is equally applicable to any cashless payment device, for example and without limitation, contactless RFID-enabled devices including smart cards, NFC-enabled smartphones, electronic mobile wallets or the like. The payment device 14 here is emblematic of any transaction device, real or virtual, by which the device holder 12 as payor and/or the source of funds for the payment may be identified.

In cases where the merchant 16 has an established merchant account with an acquiring bank (also called the acquirer) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g., merchant 16). Occasionally, the merchant 16 does not have an established merchant account with an acquirer 20, but may secure payment on a transaction through a third-party payment provider 18. The third party payment provider 18 does have a merchant account with an acquirer 20, and is further authorized by the acquirer 20 and the network operator 22 to acquire payments on network transactions on behalf of sub-merchants. In this way, the merchant 16 can be authorized and able to accept the payment device 14 from a device holder 12, despite not having a merchant account with an acquirer 20.

The acquirer 20 routes the transaction request to the network operator 22. The data included in the transaction request will identify the source of funds for the transaction. With this information, the network operator 22 routes the transaction to the issuer 24. An issuer 24 is a party or entity, typically a bank, which is authorized by the network operator 22 to issue payment devices 14 on behalf of its customers (e.g., device holder 12) for use in transactions to be completed on the network. The issuer 24 also provides the funding of the transaction to the network provider 22 for transactions that it approves in the process described. The issuer 24 may approve or authorize the transaction request based on criteria such as a device holder's credit limit, account balance, or in certain instances more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision made by the issuer 24 to authorize or decline the transaction is routed through the network operator 22 and acquirer 20, ultimately to the merchant 16 at the point of sale. This entire process is typically carried out by electronic communication, and under routine circumstances (i.e., valid device, adequate funds, etc.) can be completed in a matter of seconds. It permits the merchant 16 to engage in transactions with a device holder 12, and the device holder 12 to partake of the benefits of cashless payment, while the merchant 16 can be assured that payment is secured. This is enabled without the need for a preexisting one-to-one relationship between the merchant 16 and every device holder 12 with whom they may engage in a transaction.

The issuer 24 may then look to its customer, e.g., device holder 12 or other party having financial ownership or responsibility for the account(s) funding the payment device 14, for payment on approved transactions, for example and without limitation, through an existing line of credit where the payment device 14 is a credit card, or from funds on deposit where the payment device 14 is a debit card. Generally, a statement document 26 provides information on the account of a device holder 12, including merchant data as provided by the acquirer 20 via the network operator 22.

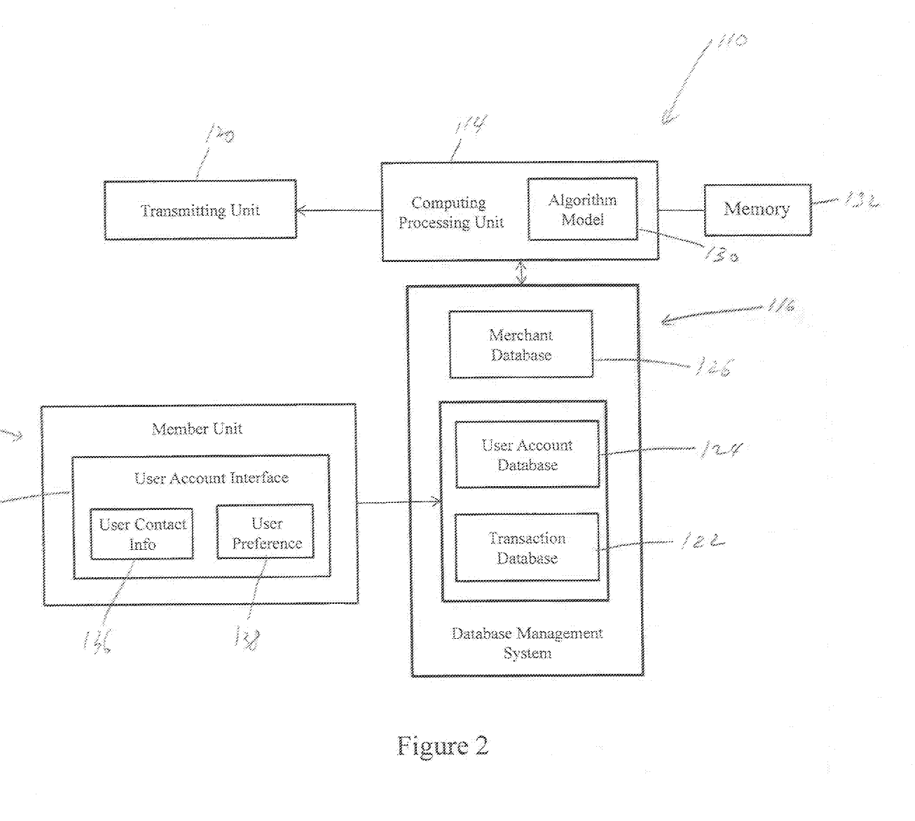

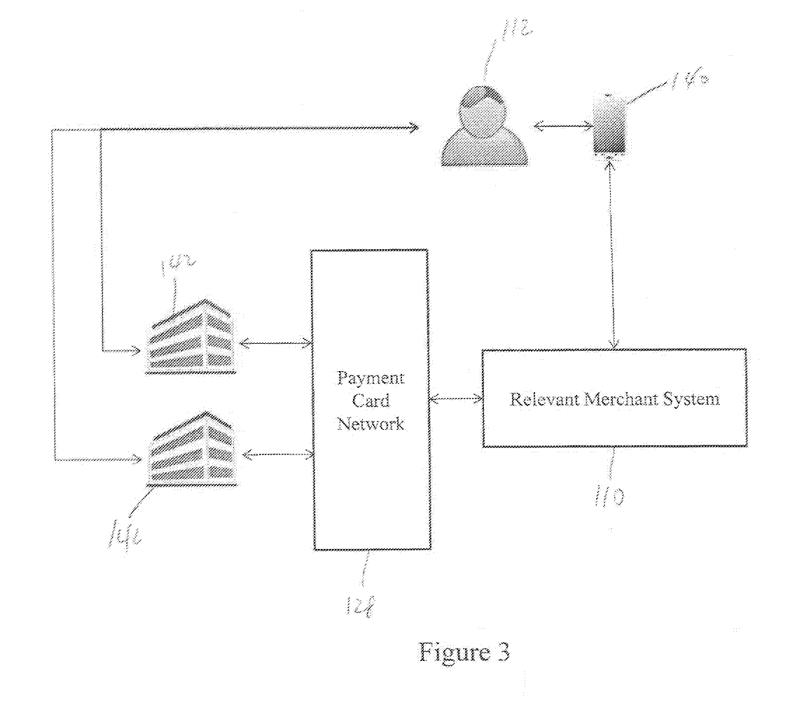

FIGS. 2 and 3 illustrate a system 110 for recommending relevant merchants for a consumer 112 at a given geographical location, according to the present invention. The present invention leverages the cashless financial transaction data (which includes past purchases) and the geographical location of the consumer 112 to generate and provide merchants located within the predetermined geographical location of the consumer that the consumer will most likely make a purchase from, based on the consumer's spending behaviors/patterns.

The present invention provides benefits to the merchants. More particularly, the present invention provides the merchants with convenient and accurate ways to attract consumers 112 to their stores. For example, an embodiment according to the present invention, the consumers 112 receive information associated with only the merchants that they may be interested in making a purchase from, thus providing an effective and efficient method for attracting the consumers 112.

The present invention also confers benefits to the consumers 112. More particularly, the present invention provides a convenient way to provide the consumers 112 with the details and information associated with the merchants that are located near them and that the consumers 112 are most likely to purchase goods and/or services from. For example, an embodiment according to the present invention, the consumer 112 receives an alert notification that includes relevant merchants based on the consumer's spending behaviors/patterns that are in close proximity to the geographical location of the consumer 112. Thus, the present invention can potentially help the consumer 112 by reducing the time and effort associated with searching for the merchants to purchase goods and/or services.

Referring again to FIGS. 2 and 3, the system 110 according to the present invention generally includes one or more computing processing units (CPUs) 114, one or more database management systems 116, a member unit 118 and a transmitting unit 120. The one or more database management systems 116 are configured to manage a plurality of databases, including, but not limited to, a transaction database 122, a user account database 124 and a merchant database 126. Alternately, each of the plurality of databases 122, 124, 126 may be separately managed by individual database management systems 116.

The one or more CPUs 114 may include application-specific circuitry including the operative capability to execute the prescribed operations integrated therein, for example, an application specific integrated circuit (ASIC) and/or microprocessor. Each CPU 114 is operatively linked, hard wired and/or wirelessly, to the one or more payment device networks 128. The one or more CPUs 114 are configured to interface with the plurality of databases 122, 124, 126 in the database management system 116. The CPUs 114 are operative to act on a program or set of instructions stored in the database management system 116. Execution of the program or set of instructions causes one of the CPUs 114 to carry out tasks such as locating data, retrieving data, processing data, etc. In addition, the one or more CPUs 114 can execute a plurality of algorithm models 130, which are utilized to evaluate/analyze the consumer's spending behaviors/patterns based on the financial transactions stored in the plurality of databases 122, 124, 126 and generate a relevant merchant profile, a plurality of consumer vectors and a plurality of merchant vectors for each consumer 112. The plurality of consumer vectors and the plurality of merchant vectors are applied to the plurality of algorithm models 130 to produce the relevant merchant profile of each consumer 112 and to further refine the relevant merchant profile if necessary. The plurality of algorithm models 130, the relevant merchant profile, the plurality of consumer vectors and the plurality of merchant vectors will be discussed in greater detail below.

The one or more CPUs 114 may further be configured to monitor financial transactions being transmitted over the one or more payment device networks 128. Little or no modification may be required to the payment device networks 128 to allow the CPUs 114 to review and collect the financial transactions. The CPUs 114 may also be configured to identify financial transactions, which may be potentially relevant in generating the relevant merchant profile and the plurality of vectors for each consumer 112. Once identified, the financial transactions may be stored in an electronic memory 132, which is operatively linked to the CPU 114. The electronic memory 132 may be provided at the same physical location (computing unit) as the CPU 114, and/or may be provided at a different location remote from the location of the CPU 114. The electronic memory 132 can include any combination of random access memory (RAM), read only memory (ROM), a storage device including a hard drive, or a portable, removable computer readable medium, such as a compact disk (CD) or a flash memory, or a combination thereof.

The transaction database 122 is configured to store financial transaction details that are contained in ISO 8583 formatted data. The ISO 8583 formatted data may be extracted by parsing the financial transactions that are monitored and identified by the CPUs 114. Each financial transaction record includes a unique identifier that is utilized to associate with each consumer 112 in the user account database 124. In addition, the transaction database 122 may further be configured to store and maintain data structures from any data sources such as payment network device operator's data warehouses, data feeds from third-parties (e.g., issuers, acquirer, etc.), social websites (e.g., Facebook, Twitter, etc.). The data from these third-party sources may be used to analyze spending behaviors/patterns together with the identified parse financial transactions to generate the relevant merchant profile, the plurality of consumer vectors and the plurality of merchant vectors.

The user account database 124 is configured to store information associated with the registered users of the system 110. Examples of such information are name, address, phone number, email, etc. If a consumer 112 desires to become a registered user, the consumer 112 can sign up via the online registration or the customer service. Once the consumer 112 completes the sign-up process, the consumer account is simply created by retrieving the relevant data associated with the consumer 112 from the payment device network operator's customer account database and inserting the related data, such as account number, into the user account database 124.

The merchant database 126 is configured to store data structures associated with the relevant merchant profile, the plurality of consumer vectors and the plurality of merchant vectors of each registered user (consumer) 112 of the system 110. Each profile and vector may include at least a unique consumer identifier, such as an account number or user id, such that it can be identified to associate with each registered user (consumer) 112. The relevant merchant profile and the plurality of vectors are generated using the plurality of algorithm models 130.

The data structures may be in the format that is suitable to be stored in the database type of the plurality of the databases 122, 124, 126. The plurality of databases 122, 124, 126 may be configured with any database type such as a relational database, a distributed database, an object database, an object-relational database, NoSQL database, etc. In addition, two or more of the databases 122. 124, 126 may be combined.

The CPUs 114 are operatively linked to the one or more database management systems 116. The one or more database management system 116 may be of any electronic, non-transitory form configured to manage the plurality of databases 122, 124, 126. The one or more database management systems 118 may reside on the same or different computing device from the CPUs 114. The database management system 116 may include MySQL, MariaDB, PostgreSQL, SQLite, Microsoft SQL Server, Oracle, SAP HANA, dBASE, FoxPro, IBM DB2, LibreOffice Base, FileMaker Pro, Microsoft Access and InterSystems Caché. All or a portion of the one or more database management system 116 may be maintained by a third party and/or configured as cloud storage.

The system 110 may also include the member unit for communicating between one or more users and the CPUs 114. The member unit 118 may be operatively linked, hard-wired and/or wirelessly, with the users through direct connections (hard wired, dial-in modem, wireless connection, and so forth) and/or through a network, such as a network of global computers (e.g., the Internet). The member unit 118 may be configured to provide for inputting information from the user. More specifically, the member unit 118 may include a user account interface 134 (graphical user interface (GUI)), which is capable of capturing various user provided data. The user account interface 134 allows a consumer 112 to register with the system 110 by creating a user account profile, preferably using his/her existing email address. Alternatively, the user account profile can be easily established by linking and accessing one of the consumer's existing social networking website account profiles such as Facebook, Twitter or LinkedIn. Once the user registration process is completed, the consumer 112 may log into the system 110 with the established authentication credentials (e.g., username and password) until the consumer 112 voluntarily cancels his/her user membership.

The user account interface 134 includes two main sections: user information section 136 and user preference section 138. The user information section 136 is capable of capturing the user-related information needed to establish the user membership with the system 110. Examples of the user contact information are user first name, user last name, account name, email, phone number, etc. With the user account interface 134, the user can access and manage (add, update or delete) any user information saved in the user account profile.

With the user preference section 138, user preference data may be entered into the system 110 by the registered user (consumer) 112. The user preference data refers to the data related to a purchase (transaction) that is not captured by the payment device network which the user desires to enter into the system 110 for accurate analysis of purchase behavior/patterns. A typical example of such transaction is a cash transaction. For example, if the consumer 112 purchased a toy at a toy store with cash, the consumer 112 may wish to enter the information related to this transaction into the system 110 since the payment device network cannot capture any cash transactions. Via the member unit 118, the consumer 112 would simply supply details associated with the cash transaction such as merchant category, in this case “Toy”, merchant name (store/business name), merchant location (address) and transaction amount.

Once the consumer 112 has provided and submitted all the necessary information (e.g., user information, user preference data, etc.), the member unit 118 collects the user inputted data and stores the user related information in the user account database 124 and the user preference data in the transaction database 122.

The member unit 118 can be implemented as a stand-alone application on a mobile-based platform (mobile application) such that the consumers 112 may access it over the Internet using a mobile device 140 which includes a display and an input device implemented therein. Non-limiting examples of mobile devices include a mobile phone (smartphones), tablets, personal digital assistants (PDA), smartwatches or other similar devices. The mobile devices 140 will typically access the system 110 directly through an Internet service provider (ISP) or indirectly through another network interface.

The transmitting unit 120 may be designed and configured to transmit relevant merchant alert notifications which include details associated with the relevant merchants. Such details include, but not limited to, merchant name, merchant industry, merchant address, good/service and amount of good/service. The transmitting unit 120 may transmit the relevant merchant alert notifications to the consumer 112 via one of the methods that are prevalent in the relevant art, such as e-mail, SMS, applications (web), etc.

Referring more particular to FIG. 3, the system 110 operates in conjunction with one or more payment device networks 128 with the capability to exchange data with the one or more payment device networks 128. As will be appreciated by those skilled in the art, any payment device network may be utilized, including traditional networks which communicate between merchants 142, acquirers, and issuers to authorize and clear consumer debit and credit transactions (e.g., Automated Clearing House (ACH) network). The subject invention may be used with other systems for authorizing and clearing debit and credit transactions via wireless devices such as smartphones or web-enabled applications.

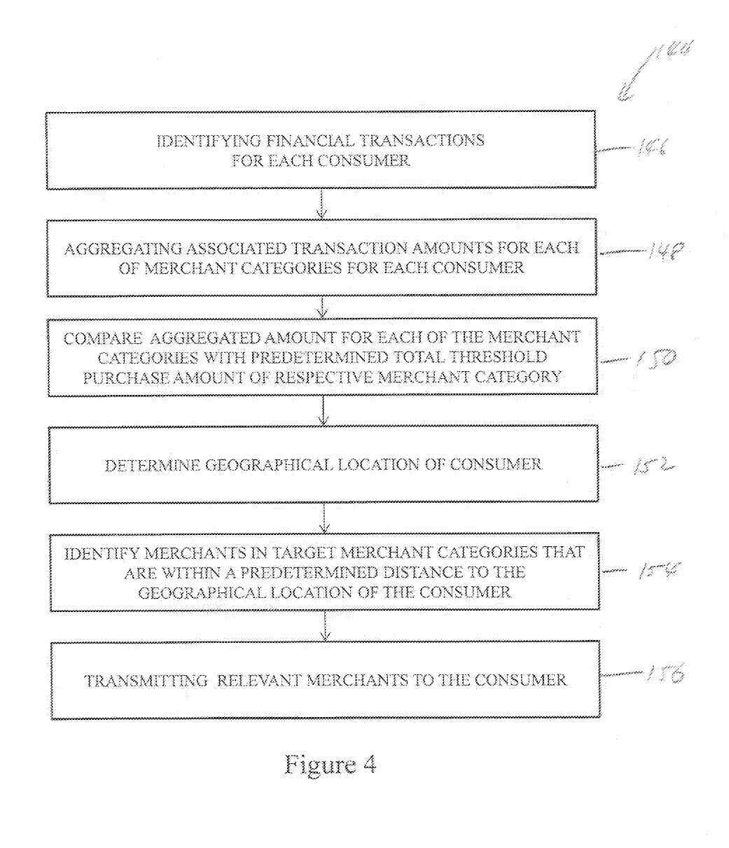

With reference to FIG. 4, a method 144 for recommending relevant merchants for a consumer 112 at a given geographical location is described in the flowchart. The method 144 may be a real-time method that enables the system 110 to generate the relevant merchant profile of the consumer 112 in a timely manner to provide relevant merchants associated with the consumer. For example, when the consumer 112 makes a new purchase at a particular store, the plurality of vectors (consumer vectors and merchant vectors) and relevant merchant profile associated with the consumer may be regenerated (incorporating the new purchase) and stored in the merchant database 126.

In a first step 146, the one or more CPUs 114 monitor financial transactions over the payment device network 128 to identify the financial transactions that are associated with each consumer in the user account database 124, using the account numbers stored in the user account database 124. The account numbers are transmitted as standard information in the identified financial transactions. Thereafter, the CPUs 114 parse the identified financial transactions associated with each consumer to extract the ISO 8583 formatted data. The extracted ISO 8583 formatted data includes, but not limited to, merchant category code, merchant category name, merchant name, merchant address, transaction amount, transaction time and transaction date (purchase date). In addition, the detailed merchant particulars may be included in optionally-used data elements, e.g., Level II and Level III data. Once all the identified financial transactions are parsed to extract the ISO 8583 formatted data, the data is processed and formatted to be stored in the transaction database 122.

In a second step 148, the financial transactions identified for the consumer 112 in the first step 146 are utilized to determine the consumer's spending behaviors/patterns. More specifically, the transaction amounts for the identified transactions, which have occurred in a predetermined time period, for example, monthly, quarterly or yearly, for each of the merchant categories (or merchant industries) are aggregated. The merchant categories may be determined by a Merchant Classification Code (MCC) used by the financial transactions in the payment device network. The MCC may be a classification of the type of business in which a particular merchant is engaged, drawn from a standardized hierarchical directory. This aggregation process determines the total transaction amount for each of the merchant categories that the consumer spent during the predetermined time period. During the aggregation process, if available, the social network data related to the consumer, such as Facebook and Twitter data, and the user preference data disclosed by the consumer may be utilized together with the identified parsed financial transactions to accurately reflect the consumer's spending behaviors/patterns.

In a third step 150, the aggregated amounts determined in the second step 148 are used to identify “target” merchant categories or merchant categories that the consumer is most likely to make purchases in the near future. More specifically, each of the aggregated amounts determined in the second step 148 is compared with the predetermined total threshold purchase amount of the respective merchant category of the consumer. The predetermined total threshold purchase amount refers to an average spending amount of the consumer for the predetermined time period. Based on the comparison, if an aggregated amount for a merchant category is less than the predetermined total threshold purchase amount of the merchant category, then the merchant category is identified as a “target” merchant category. For example, if the average monthly spending amount (predetermined total threshold purchase amount) on the “Apparel” merchant category for the consumer is $300 and the month-to-date spending amount on “Apparel” is $200, then the “Apparel” merchant category is identified as a target merchant category since the monthly total threshold purchase amount, in this case $300, has not yet been exceeded by the month-to-date spending amount of $200. However, once the month-to-date spending amount exceeds the average monthly spending amount of $300, the “Apparel” merchant category would no longer be classified as a target merchant category.

In a fourth step 152, the geographical location of the consumer's mobile device 140 is determined using methods that will be apparent to people having skill in the relevant art. For example, the geographical location of the consumer 112 may be identified by the built-in global positioning system (GPS) receiver of the consumer's mobile device 140 such as mobile phone, tablets, electronic watch/band, etc. In addition, the geographic location of the consumer's mobile device may be determined by WiFi, cellular network triangulation, etc.

In a fifth step 154, once the target merchant categories and the geographical location of the consumer are determined, the relevant merchant profile of the consumer may be generated. The relevant merchant profile contains information associated with one or more merchants in the target merchant categories identified in the third step 150 that are within the predetermined distance to the geographical location of the consumer 112. For example, if the consumer is at the intersection of 5^{th} Avenue and 57^{th} Street in New York City, the merchants in the consumer's target merchant categories that are in the vicinity of the intersection are generated. Thus, if the “Electronics” merchant category is determined as one of the consumer's target merchant categories, “5^{th} Ave Apple Store” would be one of the merchants included under the “Electronics” target merchant category in the relevant merchant profile.

In a sixth step 156, the transmitting unit 120 generates a relevant merchant alert notification based on the relevant merchants identified in the fifth step 154. Thereafter, as stated above, the transmitting unit 120 transmits the generated relevant merchant alert notification to the consumer's mobile device via one of the delivery methods, such as e-mail, SMS, applications (web), etc. If there is no merchant in the relevant merchant profile, the new merchant alert notification will not be generated.

The plurality of algorithm models (statistical techniques) 130 are used to generate the relevant merchant profile, the plurality of consumer vectors and the plurality of merchant vectors. The plurality of algorithm models 130 perform statistical algorithms or sets of instructions or operations on various data stored in the plurality of databases 122, 124, 126. The algorithm models 130 can be designed with mathematical-based methods, rules-based methods and machine learning-based methods.

Each of the plurality of consumer vectors contain one or more attributes that are related to consumer's geographic, demographic or purchase behavioral characteristics as observed on his/her payment card transactions. For example, some of the examples of the plurality of consumer vectors contain information related to “purchase behavior by industry by day of week”, “likely to try new store by industry” and “consumer spending by industry by zip codes”. The plurality of consumer vectors consists of a plurality of consumer purchase behavior vectors and a plurality of consumer total spend vectors. Examples of the plurality of consumer purchase behavior vectors and the plurality of consumer total spend vectors are listed below in Table 1 and Table 2, respectively.

Each of the plurality of merchant vectors contains information related to profiling attributes and/or characteristics of a merchant such as “average days between two visits”, “store traffic by day of week” and “percent of new customers visiting store”. The plurality of merchant vectors consists of a plurality of merchant trend vectors and a plurality of merchant total trend vectors. Examples of the plurality of merchant trend vectors and the plurality of merchant total trend vectors are listed below in Table 3 and Table 4, respectively.

TABLE 1

| Vector | |
|---|---|
| Code | Vector Description |
| CV00: | Current geographical location of the consumer, as captured via a |
| | mobile device (mobile phone, tablet, electronic watch, etc.) |
| CV01: | Buyer segment of the consumer. A classification created |
| | leveraging SOM (Self Organizing Maps—a Neural Network |
| | technique), K-means or other clustering method on consumer's |
| | transaction data, the ‘Buyer Segment’ of the consumer given a |
| | high level purchasing profile of the consumer. Examples of such |
| | profiles are “High End Traveler”, “Discount Shopper”, “DIY”. A |
| | finite number of segments are calculated by clustering the entire |
| | universe of purchase transactions for the consumer set and |
| | leveraging information of the merchants to define the buyer |
| | segment. For example, a consumer can be mapped to a primary |
| | Buyer Segment, and multiple secondary segments based on |
| | behavioral proximity. A consumer may get mapped to a primary |
| | “High End Traveler”, but may also get mapped to secondary |
| | segments with weaker strength for e.g. to “Internet Shopper” and |
| | “Pet Lovers”. |
| CV02: | An index is calculated for the consumer in every merchant |
| | category (grocery, eating places, etc.) that captures how far |
| | above or below is the average consumer's ticket in the merchant |
| | category as compared to the average ticket distribution curve for |
| | the category. For example, a consumer may be over-index |
| | average spend in eating-places, but under-index in average |
| | spending at discount department stores. |
| CV03: | Holds the average, minimum and the maximum that the |
| | consumer spends by merchant category computed by evaluating |
| | the last 6-12 months of purchase data. For example, a consumer |
| | may spend on average $45.02 when eating out, with the |
| | minimum spending at $12.96 and the maximum spending at |
| | $112.12. |
| CV04: | Holds the frequency at which a consumer shops by merchant |
| | categories. This can be segmented as daily, weekly, bi-weekly, |
| | monthly, quarterly, bi-annually and yearly. For example, a |
| | consumer may buy coffee daily, groceries weekly, gasoline bi- |
| | weekly, pay insurance premiums quarterly, airlines ticket bi- |
| | annually and high-end electronics or jewelry on an annual basis. |
| CV05: | Holds the days of the week a consumer makes purchase by |
| | merchant categories. For example, 30% of the time a consumer |
| | may eat out any day Mon.-Thurs., 50% of the time on Friday |
| | evening and the remaining 20% of time over the weekend. |
| CV06: | Holds the hour interval when a consumer makes purchase by |
| | merchant categories. For example, 50% of the time a consumer |
| | may eat out between 12:00-13:00 PM, and the remaining 50% of |
| | the time between 18:00-19:00 PM. |
| CV07: | Captures the distribution of consumer spending on-line and off- |
| | line by merchant categories including average on-line and offline |
| | ticket. For example, a consumer may purchase electronics on-line |
| | 75% of the time with an average ticket of $69 and off-line the |
| | remaining 25% of the time, with an average ticket of $790. |
| CV08: | Captures industry/merchant concentration of the consumer |
| | spending by month, seasons, key holidays and holiday seasons, |
| | etc. For example, a consumer may have high spending in out- |
| | door activities during summer months and high specialty gift |
| | purchases during December (holiday season). |
| CV09: | Captures the 5 merchant categories the consumer is most likely |
| | to visit by industry. For example, after paying for “Parking”, the |
| | consumer, based on prior spend behavior, is most likely to make |
| | a purchase at one of the following merchants (Restaurant, Bar, |
| | Coffee Shop, Live Performance, and Movie Theater). This is |
| | computed using past purchase data. |
| CV10: | Captures, in the past year, by industry, what percentage of the |
| | time the consumer made purchases at merchants that they had |
| | visited in the past, versus trying new merchants. For example, |
| | a consumer may visit 80% of the time restaurants that they |
| | have visited in the past, and only 20% of the times try new |
| | restaurants. |
| CV11: | By industry, captures the date/time, amount, and the location of |
| | the last transactions made by the consumer. |
| CV12: | Consumer spending by industry in the top 5 zip codes. For |
| | example, for dry-cleaning a consumer may have 10589 |
| | (residential zip code) here and blanks for the remaining fields |
| | as the consumer only does dry cleaning only in their residential |
| | zip code. |
| CV13: | Consumer preferences in sub-categories. For example, for eating |
| | out, a consumer may prefer eating out at Thai restaurants, then |
| | Vegan restaurants and then Chinese cuisine. |

TABLE 2

| Vector Code | Vector Description |
|---|---|
| CT00 | Total MTD and YTD consumer spending by industry. |
| CT01 | Average monthly and yearly spent by industry |

TABLE 3

| Vector | |
|---|---|
| Code | Vector Description |
| MV00 | Geo-location of the merchant (lat, long). This will be static, |
| | unless the business is mobile, e.g. Food Trucks. |
| MV01 | Key consumer buyer segments that shop at the merchant e.g. |
| | “High-end traveler”, “Discount Shopper”, “DIY”, “Auto |
| | Enthusiast”, “Pet Lovers”, etc. |
| MV02 | An index that pegs the merchant on average ticket relative to |
| | the industry. E.g. Average ticket at the merchant is $32.05 |
| | while the average ticket for the industry is $22.99. An index |
| | greater than 1.0 for the merchant will indicate that it is a |
| | higher end store. |
| MV03 | Holds the average, minimum, maximum and the standard |
| | deviation of the average ticket at the merchant. |
| MV04 | Holds the average days between two consecutive visits of |
| | returning customer at the store (computed using last 12 |
| | months of data). |
| MV05 | Holds the store traffic by days of the week by month. |
| MV06 | Holds the store traffic by hour interval by day of the week |
| | by month. |
| MV07 | Captures the % of sales at store front vs. on-line |
| MV08 | Captures sales index by key holidays and holiday seasons, |
| | etc. Example, 3× average monthly purchases in December |
| | (holiday season). |
| MV09 | Captures the most likely merchant categories the consumer |
| | visits before making a purchase at this store. |
| MV10 | % of new customers vs. repeat customer at the store |
| | computed over 1, 3, and 6 months. |
| MV11 | Store hours by days of the week. |
| MV12 | The top 5 zip codes that the merchant draws most of its |
| | customers from. |
| MV13 | Merchant's sub category code if applicable e.g. Vegan, or |
| | Chinese cuisine. |

TABLE 4

| Vector Code | Vector Description |
|---|---|
| MT00 | Sales growth of index of the merchant in the industry |
| | (computed using transaction data) |
| MT01 | Consumer loyalty index of the merchant in the industry |
| | (computed using transaction data) |
| MT02 | % returns at the store indexed for the industry. |

The relevant merchant profile generated in the fifth step 154 may be refined by applying various consumer vectors and merchant vectors (Tables 1-4) to the plurality of algorithm models 130. More specifically, by effectively evaluating the strength of correlation between various consumer vectors and merchant vectors associated with the consumer, the relevant merchant profile may be filtered to include only merchants that satisfy the applied consumer vectors and merchant vectors.

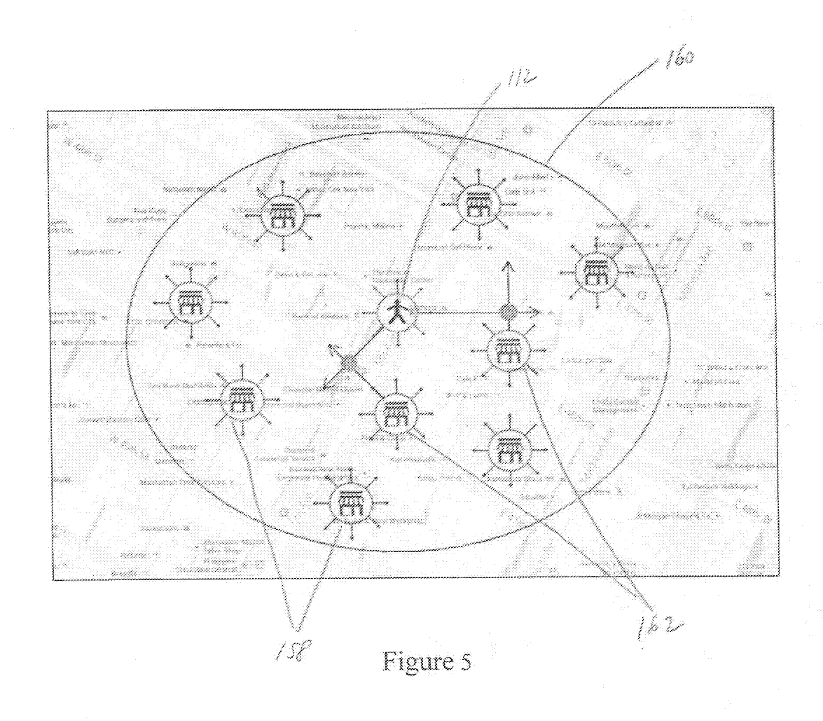

FIG. 5 is an exemplary illustration of refined relevant merchants of the consumer 112 at a given geographical location. As illustrated in FIG. 5, the consumer 112 is located at the intersection of 6^{th} Avenue and 48^{th} Street in New York City. As stated above, the geographical location of the consumer 112 may be determined via the mobile device 140 of the consumer. The system 110 processes the steps 146, 148, 150, 152, 154 described above and generates the relevant merchant profile of the consumer 112, which includes merchants 158 in the consumer's identified target merchant categories that are within the predetermined distance (circle 160 in FIG. 5) to the intersection. Thereafter, the relevant merchant profile may be refined by applying the plurality of consumer vectors and the plurality of merchant vectors listed in Tables 1-4 above. In one example, “Dining” is included in the relevant merchant profile as one of the consumer's identified target merchant categories. In this example, by analyzing and applying various vectors to the plurality of algorithm models 130, the merchants for the “Dining” category may be filtered to provide relevant merchants that closely reflect the spending pattern of the consumer 112. For example, since the consumer's preferred type (e.g., cuisine) of restaurants may be determined via “consumer preferences in sub-categories” vector (CV13), the relevant merchants list for the “Dining” category may be refined to include only restaurants 162 that the consumer 112 prefers, such as “Italian restaurants.” Further refinement of the relevant merchants for the “Dining” category may be performed by applying the consumer vectors such as “percentage of the time the consumer made purchases at merchants that the consumer visited in the past versus new merchants” vector (CV10). Depending on the strength of the vector (CV10), the relevant merchants list for the “Dining” category may include new Italian restaurants within the predetermined distance (circle 160 in FIG. 5) to the intersection.

Other consumer and/or merchant vectors may also be utilized to refine the relevant merchant profile. For example, if the identified target merchant category is “Apparel”, the strength of correlation between “consumer's spending behavior of online and offline by merchant categories” (CV07) and “percent of sales at the merchant physical store and merchant online store” (MV07) may be evaluated and determined to filter out only merchants 162 that represent strong correlation between CV07 and MV07. Further refinement of the relevant merchant profile may be performed by evaluating the strength of other consumer vector and merchant vector such as “consumer's average and standard deviation of spending in the industry” (CV03) and “average and standard deviation of spending at the merchant” (MV03). It will be appreciated by one skilled in the art that the relevant merchant profile may be further refined by applying other consumer and merchant vectors until the desired relevant merchant profile is generated.

It will be appreciated by one skilled in the art that the present invention is not limited to the plurality of consumer vectors and the plurality of merchant vectors listed in the Tables 1, 2, 3 and 4 above. The present invention may generate any additional consumer vectors and merchant vectors deemed necessary.

What is claimed is:

1. A method for recommending relevant merchants for a consumer at a given geographical location, the method comprising:
identifying transactions processed over at least one payment device network as being associated with a payment network account of a consumer;
parsing the identified transactions to extract ISO 8583 formatted data, wherein the ISO 8583 formatted data representing, where present, for each of the identified transactions, at least an associated merchant category code, an associated merchant category name, an associated merchant name, an associated merchant address and an associated transaction amount;
aggregating, using a computing processing unit, the associated transaction amounts for the identified transactions for each of the associated merchant categories, wherein all of the identified transactions for each of the associated merchant categories occurred in a predetermined time period;
comparing, using the computing processing unit, the aggregated amount for each of the associated merchant categories with a predetermined total threshold purchase amount of a respective merchant category of the consumer and wherein, for each of the aggregated amounts being less than the predetermined total threshold purchase amount, identifying the associated merchant category as a target merchant category;
determining geographical location of the consumer via a global positioning system (GPS) receiver of a mobile device of the consumer;
identifying, using the computing processing unit, merchants of each of the identified associated merchant categories within a predetermined distance to the geographical location of the consumer; and
transmitting, using a transmitting unit, an alert including a list of the identified merchants to the mobile device of the consumer.

2. The method of claim 1, wherein the list of the identified merchants of each of the identified associated merchant categories within the predetermined distance to the geographical location of the consumer is refined by evaluating the strength of correlation between a plurality of consumer vectors and a plurality of merchant vectors.

3. The method of claim 2, wherein the plurality of consumer vectors and the plurality of merchant vectors are generated by leveraging the identified transactions of the consumer.

4. The method of claim 3, wherein the plurality of consumer vectors and the plurality of merchant vectors are generated by leveraging data from social network websites of the consumer, demographics data provided by the consumer and preference data provided by the consumer.

5. The method of claim 2, wherein the plurality of consumer vectors includes a plurality of consumer purchase behavior vectors and a plurality of consumer total spend vectors.

6. The method of claim 5, wherein the plurality of consumer purchase behavior vectors include consumer geographical location, buyer segment of the consumer, purchase affluence indicator by merchant categories, average, minimum, maximum and standard deviation of average spending by merchant categories, purchase frequency cycle by merchant categories, purchase behavior by merchant categories days of the week, purchase behavior by merchant industries by hours, purchase behavior by merchant categories by online and offline average spending, purchase behavior by season, months and holidays, purchase sequence pattern by merchant categories, likely to try new store by merchant categories, consumer spending by merchant categories by zip codes, and consumer sub-category preferences by merchant categories.

7. The method of claim 5, wherein the plurality of consumer total spend vectors include total month-to-date and year-to-date spending by merchant categories, average monthly and yearly spending by merchant categories, and details of the last transaction.

8. The method of claim 2, wherein the plurality of merchant vectors includes a plurality of merchant trend vectors and a plurality of merchant total trend vectors.

9. The method of claim 8, wherein the plurality of merchant trend vectors include merchant geographical location, key buyer segments of consumers visiting the merchant, affluent profile of the store, average, minimum, maximum and the standard deviation of the average spending, average days between two consecutive visits, store traffic by days of the week, store traffic by hour interval, percentage of sales of online and offline, sales traffic by season, month and key holidays, purchase sequence traffic, percentage of new customers and return customers, store hours by days of the week, merchant feeder zip codes, and merchant sub-category.

10. The method of claim 8, wherein the plurality of merchant total trend vectors include sales growth of index of the merchant in the industry, consumer loyalty index of the merchant in the industry, and merchant return index relative to the industry.

11. The method of claim 1, wherein the mobile device includes mobile phones, smartphones, tablets and smartwatches.

12. A non-transitory machine-readable recording medium storing thereon a program of instruction which, when executed by a processor, cause the processor to:
identify transactions processed over at least one payment device network as being associated with a payment network account of a consumer;
parse the identified transactions to extract ISO 8583 formatted data, wherein the ISO 8583 formatted data representing, where present, for each of the identified transactions, at least an associated merchant category code, an associated merchant category name, an associated merchant name, an associated merchant address and an associated transaction amount;
aggregate, using a computing processing unit, the associated transaction amounts for the identified transactions for each of the associated merchant categories, wherein all of the identified transactions for each of the associated merchant categories occurred in a predetermined time period;
compare, using the computing processing unit, the aggregated amount for each of the associated merchant categories with a predetermined total threshold purchase amount of a respective merchant category of the consumer and wherein, for each of the aggregated amounts being less than the predetermined total threshold purchase amount, identifying the associated merchant category as a target merchant category;
determine geographical location of the consumer via a global positioning system (GPS) receiver of a mobile device of the consumer;
identify, using the computing processing unit, merchants of each of the identified associated merchant categories within a predetermined distance to the geographical location of the consumer; and
transmit, using a transmitting unit, an alert including a list of the identified merchants to the mobile device of the consumer.

13. The medium according to claim 12, wherein the list of the identified merchants of each of the identified associated merchant categories within the predetermined distance to the geographical location of the consumer is refined by evaluating the strength of correlation between a plurality of consumer vectors and a plurality of merchant vectors.

14. The medium according to claim 13, wherein the plurality of consumer vectors and the plurality of merchant vectors are generated by leveraging the identified transactions of the consumer.

15. The medium according to claim 14, wherein the plurality of consumer vectors and the plurality of merchant vectors are generated by leveraging data from social network websites of the consumer, demographics data provided by the consumer and preference data provided by the consumer.

16. The medium according to claim 13, wherein the plurality of consumer vectors includes a plurality of consumer purchase behavior vectors and a plurality of consumer total spend vectors.

17. The medium according to claim 16, wherein the plurality of consumer purchase behavior vectors include consumer geographical location, buyer segment of the consumer, purchase affluence indicator by merchant categories, average, minimum, maximum and standard deviation of average spending by merchant categories, purchase frequency cycle by merchant categories, purchase behavior by merchant categories days of the week, purchase behavior by merchant industries by hours, purchase behavior by merchant categories by online and offline average spending, purchase behavior by season, months and holidays, purchase sequence pattern by merchant categories, likely to try new store by merchant categories, consumer spending by merchant categories by zip codes, and consumer sub-category preferences by merchant categories.

18. The medium according to claim 16, wherein the plurality of consumer total spend vectors include total month-to-date and year-to-date spending by merchant categories, average monthly and yearly spending by merchant categories, and details of the last transaction.

19. The medium according to claim 13, wherein the plurality of merchant vectors includes a plurality of merchant trend vectors and a plurality of merchant total trend vectors.

20. The medium according to claim 19, wherein the plurality of merchant trend vectors include merchant geographical location, key buyer segments of consumers visiting the merchant, affluent profile of the store, average, minimum, maximum and the standard deviation of the average spending, average days between two consecutive visits, store traffic by days of the week, store traffic by hour interval, percentage of sales of online and offline, sales traffic by season, month and key holidays, purchase sequence traffic, percentage of new customers and return customers, store hours by days of the week, merchant feeder zip codes, and merchant sub-category.

21. The medium according to claim 19, wherein the plurality of merchant total trend vectors include sales growth of index of the merchant in the industry, consumer loyalty index of the merchant in the industry, and merchant return index relative to the industry.

22. The medium according to claim 12, wherein the mobile device includes mobile phones, smartphones, tablets and smartwatches.

23. A system for recommending relevant merchants for a consumer at a given geographical location, the system comprising:
one or more computing processing units configured to monitor financial transactions being transmitted over one or more payment device networks and to execute a plurality of algorithm models;
a member unit configured to provide a graphical user interface to the consumer for registering to the system, creating a user account profile and inputting user preference data;
one or more database management systems, each of the one or more database management systems including:
a user account database configured to store data associated with the consumer,
a transaction database configured to store financial transactions identified by the one or more computing processing units, and
a merchant database configured to store data structures corresponding to a relevant merchant profile, a plurality of consumer vectors and a plurality of merchant vectors; and
a transmitting unit configured to transmit an alert including a list of merchants in the relevant merchant profile to the consumer.
